(19) United States
(12) Patent Application Publication
(10) Pub. No.: US 2005/0065797 A1
(43) Pub. Date: Mar. 24, 2005

(54) System and method for providing global navigation information for voice portlets

(75) Inventor: Walter Haenel, Holzgerlingen (DE)

Correspondence Address: Jerry W. Herndon;International Business Machines, Intellectual property Law, Dept. T81/Bldg. 503, PO Box 12195, Research Triangle Park, NC, 27709, US

(73) Assignee: International Business Machines Corporation, Armonk, NY (US)

(21) Appl. No.: 10/930,593

(22) Filed: Aug. 31, 2004

(30) Foreign Application Priority Data
Sep. 24, 2003 (DE) 03103544.7

(51) Int. Cl. G10L 21/00

(52) U.S. Cl. 704/270.1

(57) ABSTRACT

The present invention provides a new system and method for generating navigation information for Voice Portlets accessible via a Portal application by assigning during runtime global navigation information to any document containing Portal selection information derived from a navigation structure model, and assigning during runtime global navigation information to each Voice Portlet document generated by a Voice Portlet, and sending those documents with their assigned navigation information to a Voice application. The Voice application is used in way to execute the Voice Portlet documents by calling a sub-dialog creating an additional execution environment to the already existing execution environment for previous documents containing Portal selection information. The additional created execution environment provides access only to the global navigation information assigned to the Voice Portlet, and the previously created execution environment provides only access to the global navigation information assigned to any document containing Portal selection information provided by the Portal application.

### FIELD OF THE PRESENT INVENTION

The present invention relates to a Voice Portal in general, and in particular to a Voice Portal that consists of a Voice application and a Portal application providing access to Voice application plugins or so called Voice portlets, and more particularly to a method and system to generate navigation information for Voice portlets by the Portal application and to provide them to the Voice application for their execution.

### BACKGROUND OF THE PRESENT INVENTION

The Voice Portal consists of a Voice Server System (e.g. IBM iSeries Server; 3) that runs a Voice application (4) and a Web Server/Portal Server System (e.g. IBM iSeries Server; 8) that runs a Portal application (e.g. IBM Websphere Portal application; 9). The Voice Server System has a communication link (e.g. PSTN or cell network; 2) to phones (1), and a communication link (e.g. Internet or Intranet; 7) to the Web Server system (8). The Portal application (9) provides access to Voice Portlets (12). Voice Portlets are application plugins that provide a user interface and an interface for accessing specific content. The Voice Portlet preferably provides a Voice Portlet document in VoiceXML (VXML). The Voice application preferably comprises a recognition engine that tries to recognize words defined in a grammar out of the audio stream, a Text to Speech engine that converts words into audio stream, a Speech browser (4) that interprets VXML documents generated by the Portal application and coordinates the work of the recognition engine and the Text to Speech engine according the instructions found in the VMXL document to generate dialogs with the Phone user (see FIG. 1).

A common visual browser (e.g. Netscape Navigator) will do; the VXML documents are requested from the Portal Server System (e.g. Web Server) by sending HTTP requests over the Intra- or Internet.

The Portal Server System forwards requests to the Portal application. The Portal application holds several Voice plugins called Voice portlets (12) that may connect through business logic beans to their backend data. The Voice portlets provide information in VXML documents (13).

It is the task of the Portal's server application aggregation component to allow the user to navigate through the system and to select the set of Voice Portlets (12) with which he or she wants to interact, as well as to collect and aggregate the output of the set of Voice Portlets into a common document.

Due to the limitation of the VoiceServer, the user can only interact with a single Voice Portlet at a given time, or the navigation dialog that is generated by the Voice Portlet Selection component.

The aggregation state 10 keeps track of where in the navigation structure the user is, and the currently activated Voice Portlets.

The aggregated VXML document is then sent back to the Speech browser (4) until the browser hits a link to another page that starts a new HTTP request.

Since some of the dialogs with the user are needed in multiple places, VXML allows the definition of subdialogs. To isolate the execution environment of a subdialog from the currently running dialog, VXML specifies that the dialog has to be executed in its own execution environment.

The speech browser (4) state keeps track of the currently used execution environment (6), and when a subdialog completes allows the system to return to the previous used execution environment (6).

### STATE OF THE ART

Prior Art Portal applications use the concept of self containing Voice Portlets. This means that it provides visual as well as voice application plugins or so called Voice Portlets. FIG. 2 shows an image of a typical navigation tree generated by the prior art Portal applications. Starting at the root node of this navigation tree, the Navigation component generates a document containing page selection that allows the user to select between the navigation nodes “Voice” and “Speech”. The result of this selection is sent by the Speech browser with the next HTTP request to the Aggregation component. The Aggregation component changes its state according the selection and returns another selection document. For example if the user selects “Voice”, a selection is generated allowing the user to select “Information”, or “email”. The selection is repeated until a Voice Portlet is selected, e.g. the News Voice Portlet after the selection of the “Information” node. In this case, the Aggregation component includes the Voice Portlet generated markup fragment into the response document instead of a selection dialog created by the Navigation component. To isolate the Voice Portlets from each other and from the system, the Voice Portlet output has to be coded as a subdialog, using the isolation feature of the speech browser. Without this isolation, one Voice Portlet could unintentionally change the state of another by using the same names. The state of the art Portal applications is limited in the flexibility of the navigation tree, in that its root component and the children of it only can have navigation nodes as children. The grand children of the root node are the only nodes that can refer to Voice Portlets and must not have navigational nodes as children. It is the task of the Aggregation component, to enhance the voice capabilities of a Voice Portlet by global navigation information that allow the user to transition out of the Voice Portlet dialogs to defined points in the Voice Portlet navigation, or other Voice Portlets. Since the Voice Portlet is written without knowing which global navigation commands are implemented in the portal, they have to be added by the portal at runtime.

FIG. 3 illustrates some of the global navigation possibilities, which are introduced by the prior Portal applications and are active, after the Voice portlet is activated from a Voice Portlet selection menu. The command “go back” (b) ends the portlet and returns to the previous selection menu; the name of another portlet application ends the current portlet dialog and starts another portlet (c); the command “Portal Home” ends the current portlet dialog and presents the initial selection dialog (d); the command “hang up” ends the dialog with the portlet and hangs up the phone line (e); and the command “next application” (f) ends the current portlet dialog and starts another portlet, which is the next on the list.

The Voice Portlets (h) and (g) may or may not implement a portal internal navigation, as shown for Voice Portlet (h).

FIG. 4 shows a typical prior art transition flow between VXML documents sent from the prior art Portal application to the Speech Browser of the Voice Portal. On the first request of the speech browser, the initial selection dialog (Portal Home; 1) is generated by the Aggregation component with the help of the Navigation component. After a user selection, the transition leads to the second level of selection (Select Page) overwriting the previous one. Selecting a valid page-transitions to a document containing a Voice Portlet selection menu (3). The Voice Portlet Selection document (3) is using the VXML <link> element to build up the selection menu. A link defines a grammar, and a corresponding action in case such a grammar is matched by a user input. In this case, the grammar is composed from the Voice Portlet name, and for each Voice Portlet such a link is generated. Additionally, this document holds links for the global navigation commands that are also active while in this document, but maybe with a different action. If such a selection link is matched, the corresponding Voice Portlet is activated using a subdialog call, resulting in another document transition (3). To insert the global commands into the Voice Portlet generated dialogs, the VXML concept of the application document is used. The Voice Portlet document specifies the selection document as application root document. The links defined in the selection document are still active while the Voice Portlet is running in its execution environment 2. The Portlet document is called as a subdialog. This triggers the speech browser to start a new execution environment 2 and load the Portlet documents, which is the Voice Portlet 1. Since the application root document (selection document) is already loaded in the speech browser, only an internal copy is made in this case (4). When a global command is spoken, the link in the application root document gets active (5) and executes the actions defined in the application root document. In case this is a “Portal home” command, the action activates a transition to the Portal home document (6) that automatically loads that page. At this point, it can be seen the biggest disadvantage of this prior art concept. The Portal Home document is executed in the execution environment 2 of the Voice Portlet resulting in drawbacks that the isolation provided by the additional execution environment is broken and the old execution environment 1 is still maintained in the browser and consumes resources, but it has be lost the possibility to return to it. In the case one switches from a Voice Portlet 1 to another one (2) the resource consumption gets even worse, since another execution environment 3 is created in the browser (7). This behavior will build up execution environments over the time of the user interactions that will eat up the resources in the voice server.

To implement this, the Aggregation component uses the navigation structure model to create the documents: Portal Home page, Select page, and the Voice Portlet selection page. Other documents, like login or error pages are generated by the aggregation itself, since no knowledge of the navigational structure is needed to create them. The portlet documents are created by the aggregation filling the portlet response in a surrounding document.

The isolation between portal dialogs and portlet dialogs is broken. Additional resource consumption limits the usability of the system because of this, the use of subdialogs in navigation documents is not recommended, leading to a situation, where common actions like the exit dialog have to be coded several times into different documents.

The current state of the art is tuned to a fixed navigation structure and does not allow mixing of portlets and navigation nodes as required for later portal releases. In the current solution the speech browser stops the communication with the Portal Server System in the case the phone line hangs up without ending the session with the Portal Server System by logging out properly. This results in blocking resources in the Portal Server System until a timeout deletes the unused session. While in the Voice Portlet selection menu, Voice Portlet specific navigation links have to be deactivated, using the mentioned flag, which blocks the execution of the action, but does not prevent the recognition of the link grammar.

### OBJECT OF THE PRESENT INVENTION

Starting from this, the object of the present invention is to provide a system and method for generating navigation information for Voice Portlets,. providing that navigation information to a Voice Server System, and executing that navigation information by the Voice application avoiding the disadvantages of the prior art.

### BRIEF SUMMARY OF THE INVENTION

The present invention provides a new system and method for generating navigation information for Voice Portlets accessible via a Portal application by assigning during runtime global navigation information to any document containing Portal selection information derived from a navigation structure model, and assigning during runtime global navigation information to each Voice Portlet document generated by a Voice Portlet, and sending those documents with their assigned navigation information to a Voice Server System. The Voice Server System is used in a way to execute the Voice Portlet documents by calling a sub-dialog creating an additional execution environment to the already existing execution environment for previous documents containing Portal selection information. The additional created execution environment provides access only to the global navigation information assigned to the Voice Portlet, and the previously created execution environment provides only access to the global navigation information assigned to any document containing Voice Portal selection information provided by the Portal application.

### BRIEF DESCRIPTION OF SEVERAL VIEWS OF THE DRAWINGS

The above, as well as additional objectives, features and advantages of the present invention will be apparent in the following detailed written description.

The novel features of the present invention are set forth in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1 shows a prior art Voice Portal on which the present invention is based,

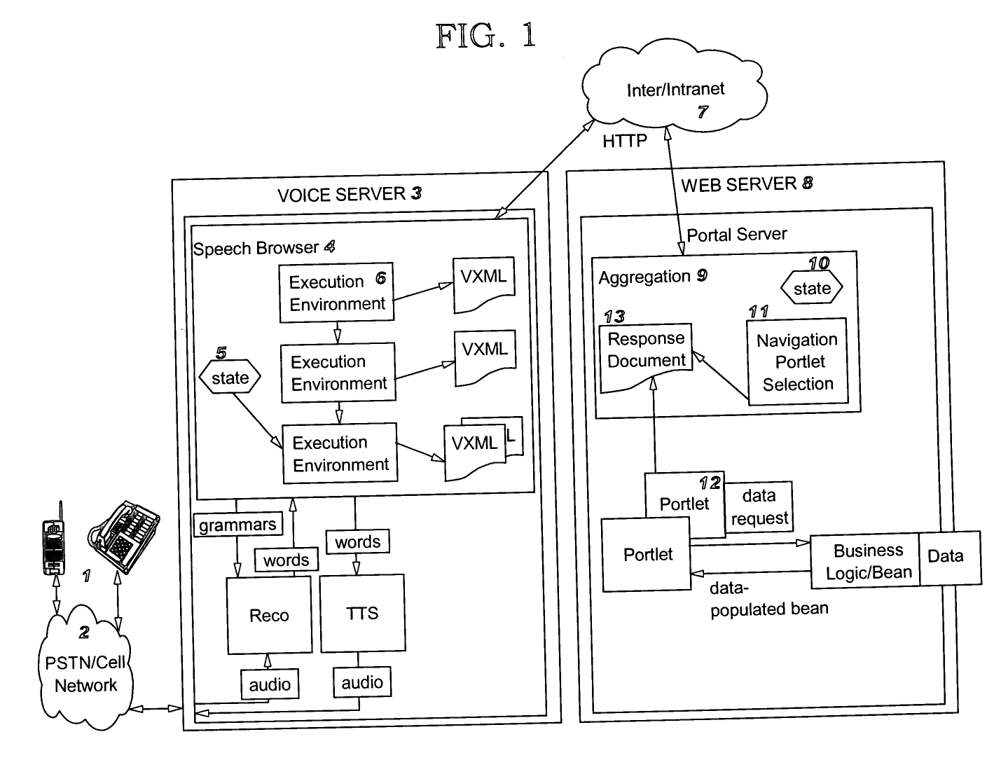

FIG. 2 shows typical navigation tree generated by a portal application,

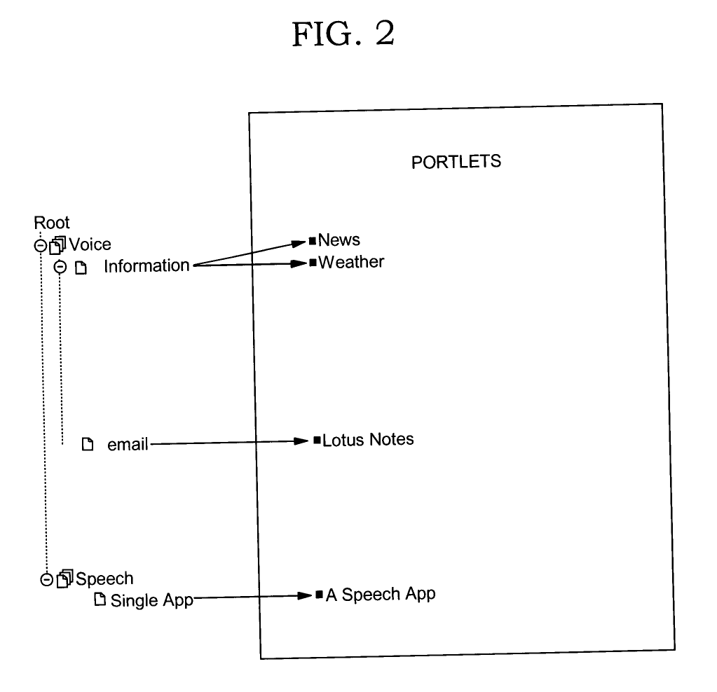

FIG. 3 shows the global navigation in a prior art Voice Portal,

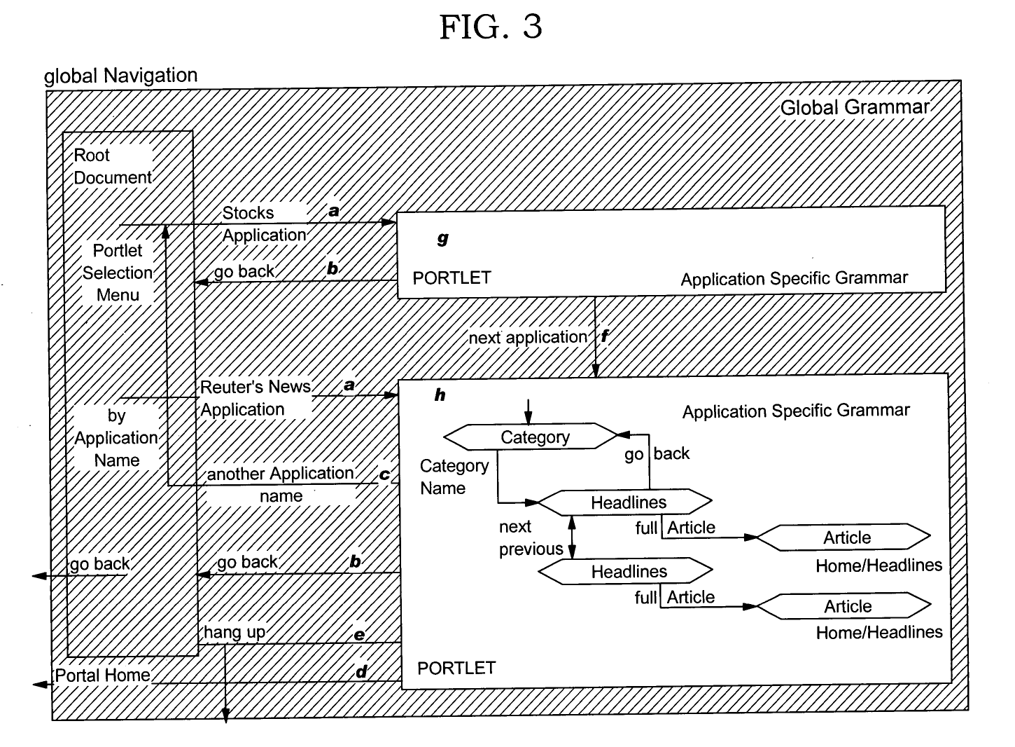

FIG. 4 shows a transition flow at the prior art Voice Server System side,

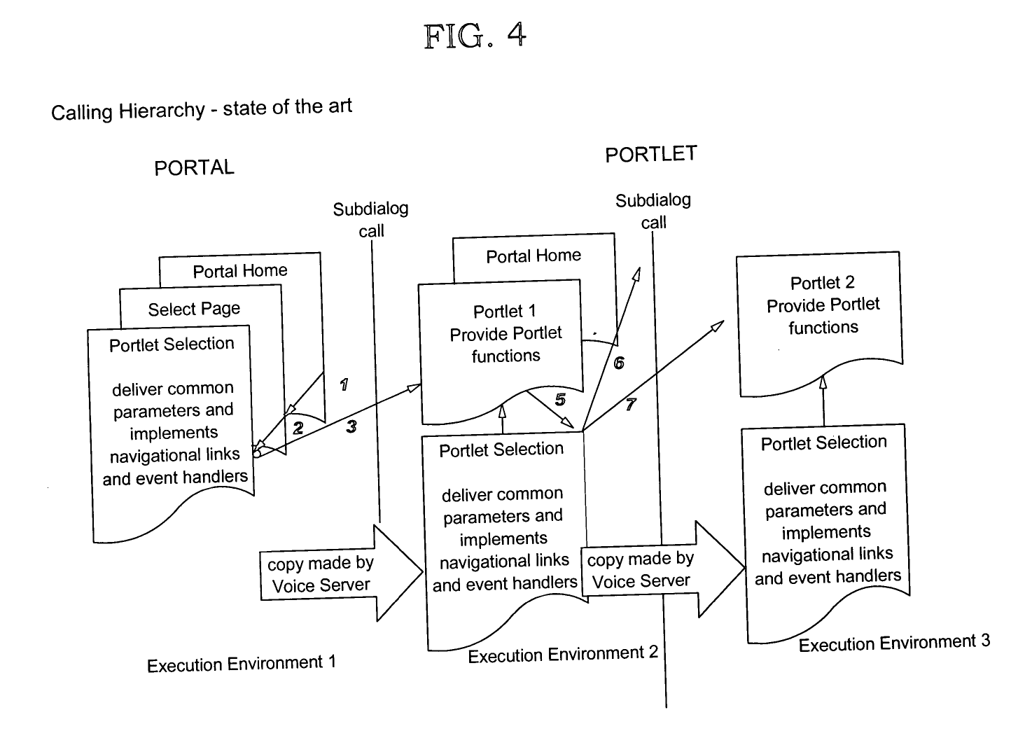

FIG. 5 shows basic system components of the inventive Voice Portal,

FIG. 6 A shows a prior art implementation of a Voice Portal,

FIG. 6 B shows an implementation of the present invention in prior art Voice Portal according to FIG. 6 A,

FIG. 7 A shows a navigation structure model as used by the prior art Voice Portal,

FIG. 7 B shows a page composition model as used by the prior art,

FIG. 7 C shows a navigation structure model as used by the inventive Voice Portal,

FIGS. 8-1 and 8-2 shows the request flow between the Voice Server System and Portal Server System when using the present invention, and

FIG. 9 shows the inventive transition flow at the Voice Server system side when using the present invention.

### DETAILED DESCRIPTION

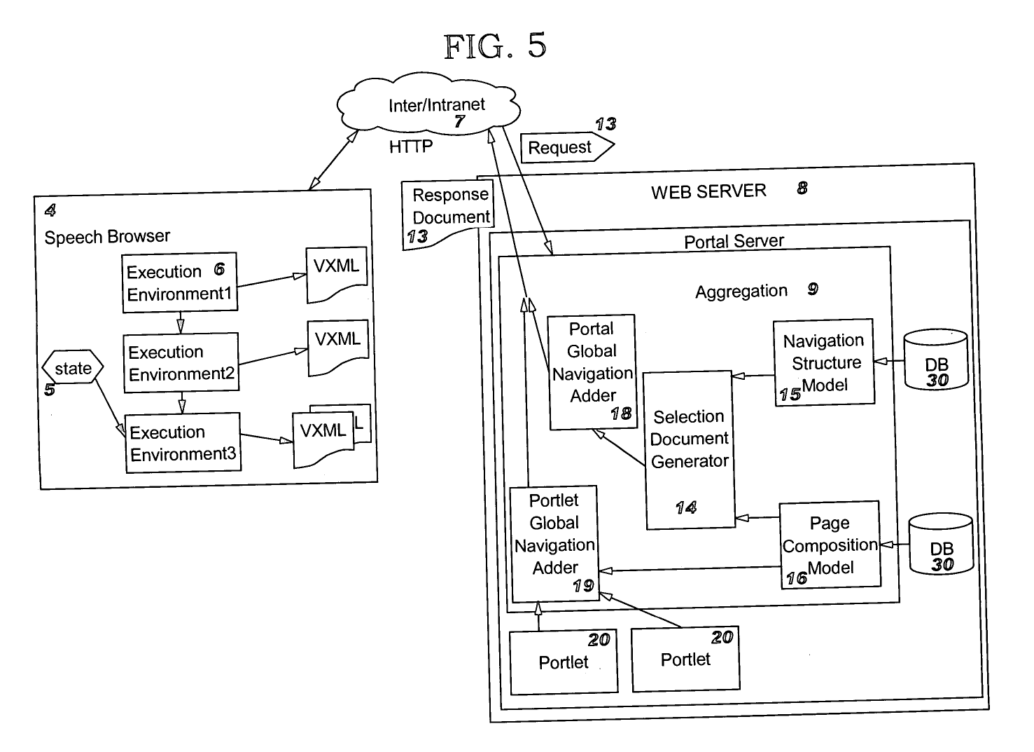

With respect to FIG. 5, there are depicted the basic system components for carrying out the present invention.

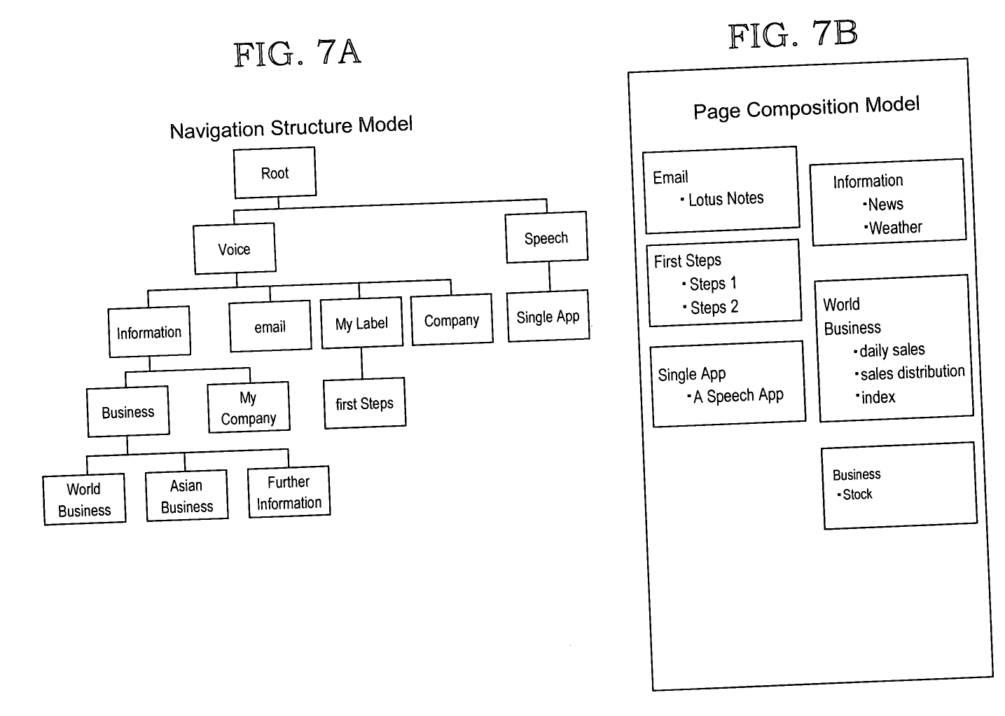

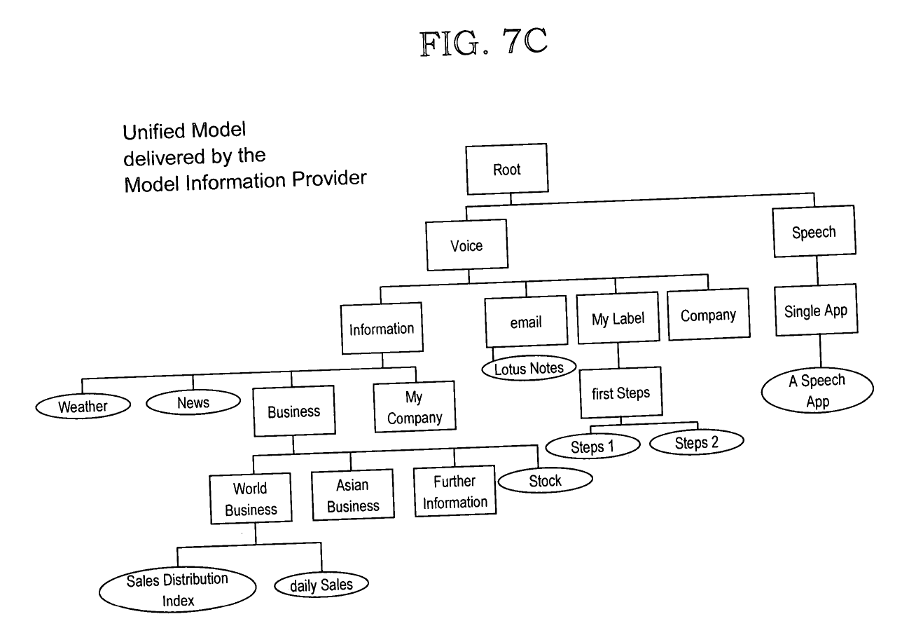

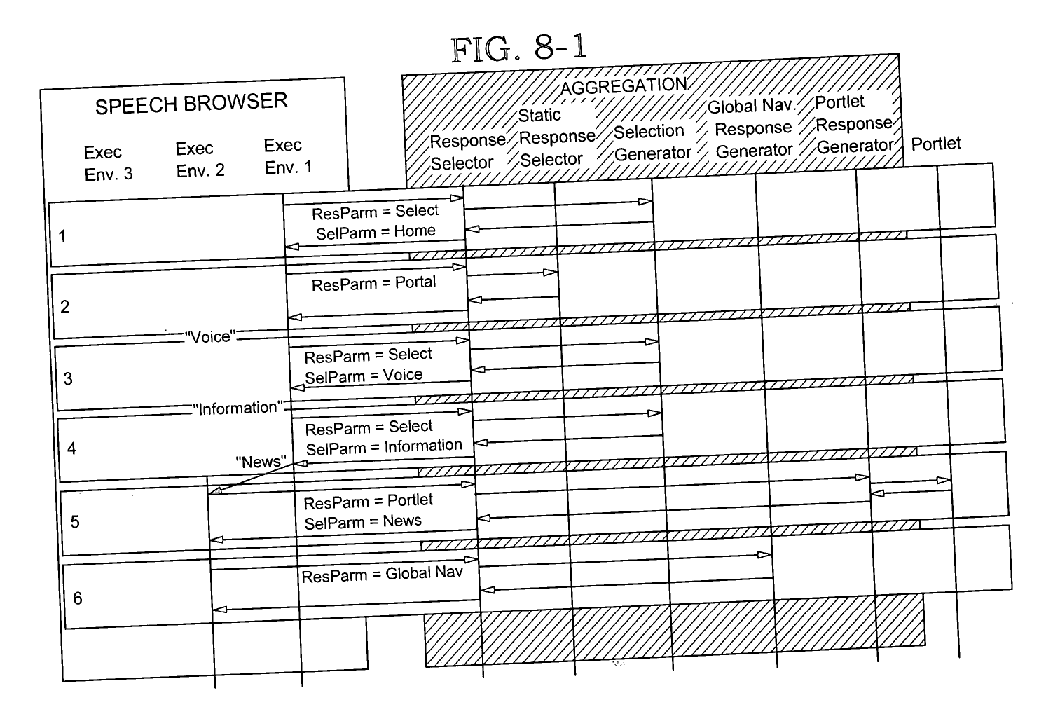

The Web Server/Portal Server System 8 runs a Portal application. The Portal application consists of at least an aggregation component 9, a selection document generator 14, a Voice Portlet navigation adder 19, and a Portal navigation adder 18. The aggregation component has access to a database 30 that provides access a navigation structure model 15, and a database 40 that provides access to a page composition model 16. The navigation structure model contains the information on the navigation structure that may be for example a navigation tree (see FIG. 7A/7C). This information defines the relations between pages defined by the Portal administrator.

The page composition model defines the information which Voice Portlet belongs to a page (see FIG. 7 B).

The Selection Document Generator 14 provides the functionality to create documents containing portal selection information derived from said navigation structure model stored on a data base 30. The generated document is preferably coded in VXML.

The Portal global navigation adder 18 provides the functionality to assign global navigation information to the generated document containing Portal selection information during runtime.

A preferred implementation of the Portal global navigation adder 18 is to extend the selection document by adding the global navigation information during runtime.

Another preferred implementation of the Portal global navigation adder 18 is to extend the selection document by adding only a reference to another document providing the global navigation information.

The selection document is sent as a HTTP response 13 to the Voice Server System 4.

The Voice Portlet global navigation adder provides the functionality to assign global navigation information to the Voice Portlet document being selected in a previous document containing Voice Portlet selection information, and generated by the Voice Portlet 20.

A preferred implementation of the Voice Portlet global navigation adder 18 is to extend the Voice Portlet document by adding the global navigation information during runtime.

Another preferred implementation of the Voice Portlet global navigation adder 18 is to extend the Voice Portlet document by adding only a reference to another document providing the global navigation information.

Furthermore, the Voice Portlet global navigation adder has an access to a page composition model (data base 30) that defines the information that Voice Portlets belong to a page, and the Voice Portlet global navigation adder provides the further functionality to assign the page composition model information to the Voice Portlet document.

The Voice Portlet document is preferably coded in VXML. However, any other markup language may used instead of VXML if it supports the concept that a Voice Portlet document is called as a sub-dialog that leads to the creation of an own execution environment for that Voice Portlet.

The Voice Portlet document is sent as a HTTP response 13 to the Voice Server.

The Voice Server system is used in way that navigation information gives access to the Voice Portlet documents by calling a sub-dialog creating an additionally execution environment to the already existing execution environment 6 for previous selections. The additionally created execution environment provides access only to the navigation information assigned to the Voice Portlet, and previously created execution environment provides only access to the navigation information assigned to any selection step provided by the Portal's navigation component.

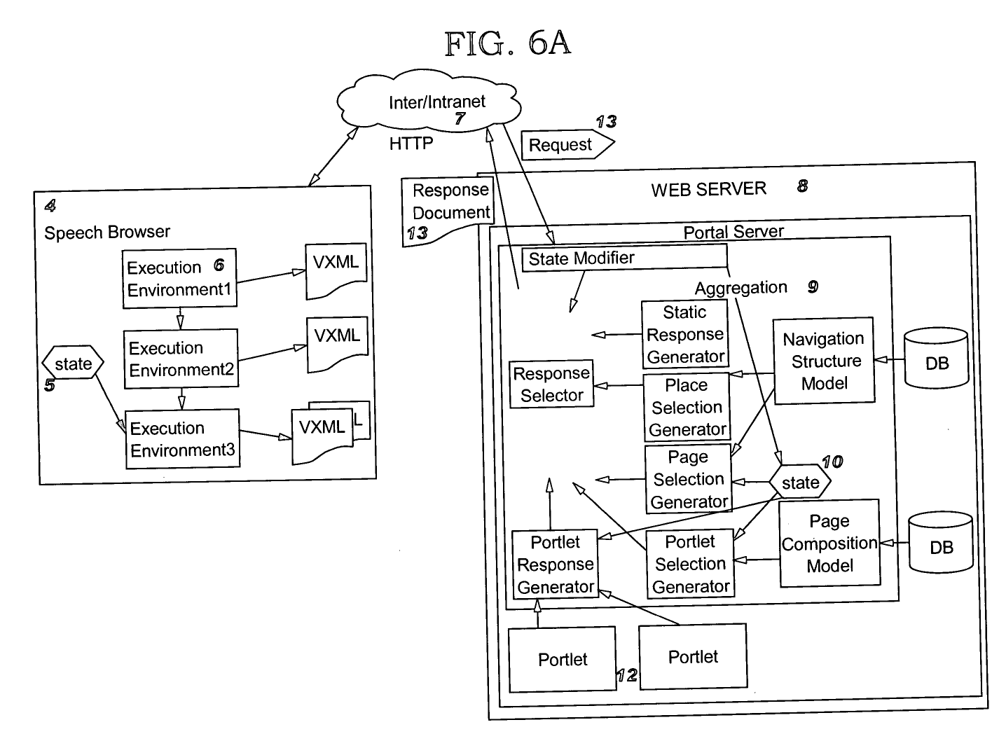

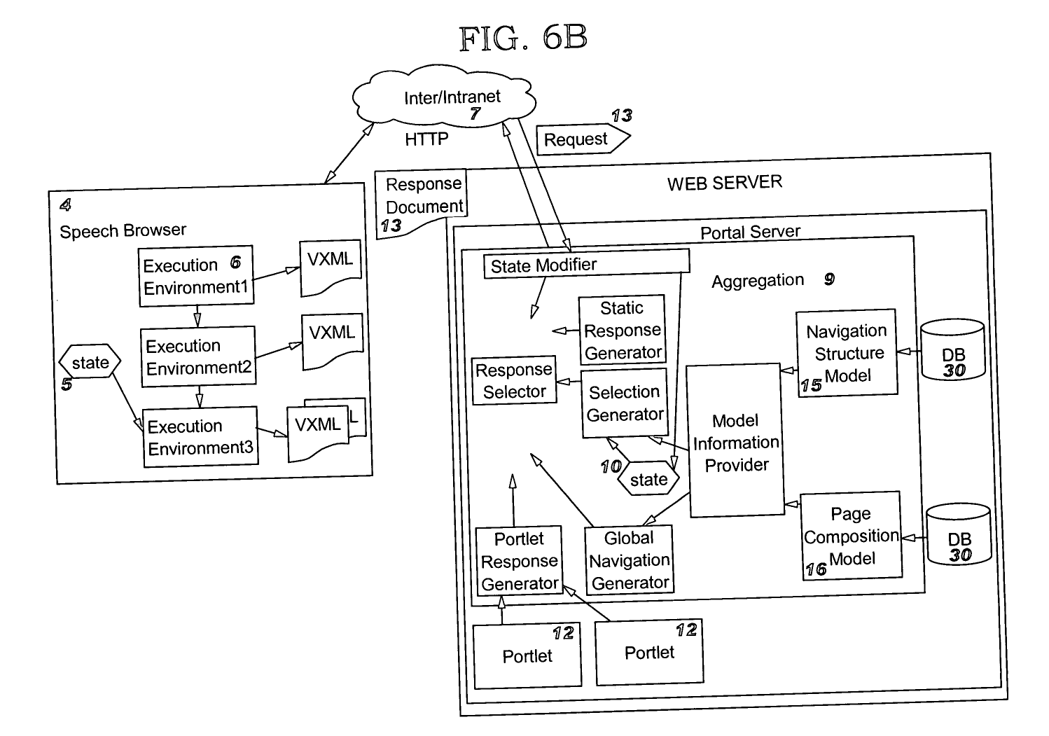

With respect to FIG. 6 A, there is depicted a prior art implementation of a Voice Portal, and with respect to FIG. 6 B, there is depicted the implementation of the present invention in that prior art Voice Portal.

The prior art implementation of a Voice Portal in FIG. 6 A comprises following components at the Portal Server System side:

The aggregation component in the Portal Server System is responsible to allow the user to select a set of Voice Portlets and to generate the output of the selected set by aggregating the output of the Voice Portlets in this set. The function of selecting the page is often also called “navigation”, since it allows the user of navigating through the content of the portal and selecting the right page. State of the art voice aggregators support only a fixed tree structure for navigation. The root of the tree is holding places, which could hold only pages. The pages finally hold a set of applications, the Voice Portlets.

The combined function of the Aggregation component is delivered from the following building blocks:

State Modifier

The state modifier receives the HTTP request and checks for additional parameters requesting a state change, which could be:

the selection of a Place

the selection of a page

the selection of a Voice Portlet on the page

other non selecting states of a Voice Portlet

after the state is modified, the HTTP request is forwarded to the response selector.

Response Selector

The response selector uses different parameters of the request to select the right response generator. The output of a response generator is then returned to the client with the HTTP response.

Static Response Generator

The static response generator provides different static responses for the speech browser. For example, the Login dialog or error dialogs.

Place Selection Generator

The place selection generator uses the navigation structure information of the Navigation structure model, to generate a selection dialog for the places. The generated VXML document will hold URL references that include the place selection information for the State Modifier

Page Selection Generator

The page selection generator uses the navigation structure information of the Navigation structure model, in combination with the aggregation state, which indicates the current selected place, to generate a selection dialog for the pages of the selected place. The generated VXML document will hold URL references that include the page selection information for the State Modifier

Voice Portlet Selection Generator

The Voice Portlet selection generator uses the page composition model that gives information on the Voice Portlets on a page, in combination with the aggregation state, which indicates the current selected page, to generate a selection dialog for the Voice Portlets of the selected place. The generated VXML document will hold URL references that include the Voice Portlet selection information for the State Modifier. In addition to this dialog, the generated VXML document will hold the links, actions, and event handles, necessary to enable the global navigation in the Voice Portlet dialogs and this selection dialog. Since the global navigation commands allow also switching to Voice Portlets on the same page, the generation of these links and actions has to be dynamic, since it holds information depending on the current selected page.

Voice Portlet Response Generator

The Voice Portlet response generator is using the state information on the selected Voice Portlet, to request the output fragment from this Voice Portlet and completes this document to generate a valid VXML document. In this completion step, a URL reference to the document generated by the Voice Portlet selection generator is inserted, to make this document to the application root document for the one generated by this generator.

State

The aggregation state holds the information on the current selection of places, page, and Voice Portlets. This information is used by some of the different generators to dynamically create the requested document. The State modifier changes the state according parameters of the request.

Page Composition Model

The page composition model holds the information that Voice Portlets belong to a page. This information is taken from a database table holding all Voice Portlet to page relations defined by an administrator.

Navigation Structure Model

The Navigation Structure Model holds the information on the navigation structure. This information is taken from a database table holding the relations between pages and places, defined by the administrator.

With respect to FIG. 6 B, there is depicted the implementation of the present invention in the prior art Voice Portal according to FIG. 6 A. Following parts of the portal aggregation are new or modified, to enable the new functionality

New components are Model Information Provider, Selection, Generator, and global Navigation Generator.

Model Information Provider

To allow a more flexible navigation structure, which allows to have Voice Portlets at all levels, the Model Information Provider unifies the 2 portal models. It takes the base structure of the navigation tree from the Navigation Structure Model and adds the Voice Portlets as new leave modes to the structure information. Resulting in a tree structure, which has pages holding Voice Portlets or other pages. This information is then provided to the generators.

Selection Generator

Taking advantage of the unified structure, the Selection Generator uses the input of the Model Information Provider and the currently selected page found in the state, to prepare a selection menu for the children ( Voice Portlets and pages) of the current page.

Global Navigation Generator

The global Navigation Generator uses the structure information from the Model Information Provider to create a document holding the global navigation links, actions, and event handles, which should be active, while in a Voice Portlet.

Modified Components are State Modifier, Response Selector, Place selection generator, Page selection generator, Voice Portlet selection generator, Voice Portlet Response Generator, and state.

State Modifier

The state modifier is modified, to allow resetting of all selections by a specific request parameter in addition to the other functions. This will allow the system to select an initial state that should allow the user to select between all children of the root navigation element.

Response Selector

It has to be adapted to the different set of output generators.

Static Response Generator

Additional to the other static documents, this generator now creates another document, which is used as application root document for all VXML documents not containing Voice Portlet output. This generated document holds the global navigation links, actions, and event handles that should be used while not in a Voice Portlet.

Place Selection Generator

The place selection generator uses the navigation structure information of the Navigation structure model, to generate a selection dialog for the places. The generated VXML document will hold URL references that include the place selection information for the State Modifier.

Page Selection Generator

The page selection generator uses the navigation structure information of the Navigation structure model, in combination with the aggregation state, which indicates the current selected place, to generate a selection dialog for the pages of the selected place. The generated VXML document will hold URL references that include the page selection information for the State Modifier.

Voice Portlet Selection Generator

The Voice Portlet selection generator uses the page composition model that gives information on the Voice Portlets on a page, in combination with the aggregation state, which indicates the current selected page, to generate a selection dialog for the Voice Portlets of the selected place. The generated VXML document will hold URL references that include the Voice Portlet selection information for the State Modifier. In addition to this dialog, the generated VXML document will hold the links and actions necessary to enable the global navigation in the Voice Portlet dialogs. Since the global navigation commands allow also switching to Voice Portlets on the same page, the generation of these links and actions has to be dynamic, since it holds information depending on the current selected page

Voice Portlet Response Generator

The Voice Portlet response generator is using the state information on the selected Voice Portlet, to request the output fragment from this Voice Portlet and completes this document to generate a valid VXML document. In this completion step, a URL reference to the document generated by the Voice Portlet selection generator is inserted, to make this document to the application root document for the one generated by this generator.

State

The aggregation state holds the information on the current selection of places, page, and Voice Portlets. This information is used by some of the different generators to dynamically create the requested document. The State modifier changes the state according parameters of the request.

Page Composition Model

The page composition model holds the information that Voice Portlets belong to a page. This information is taken from a database table holding all Voice Portlet to page relations defined by an administrator.

Navigation Structure Model

The Navigation Structure Model holds the information on the navigation structure. This information is taken from a database table holding the relations between pages and places, defined by the administrator.

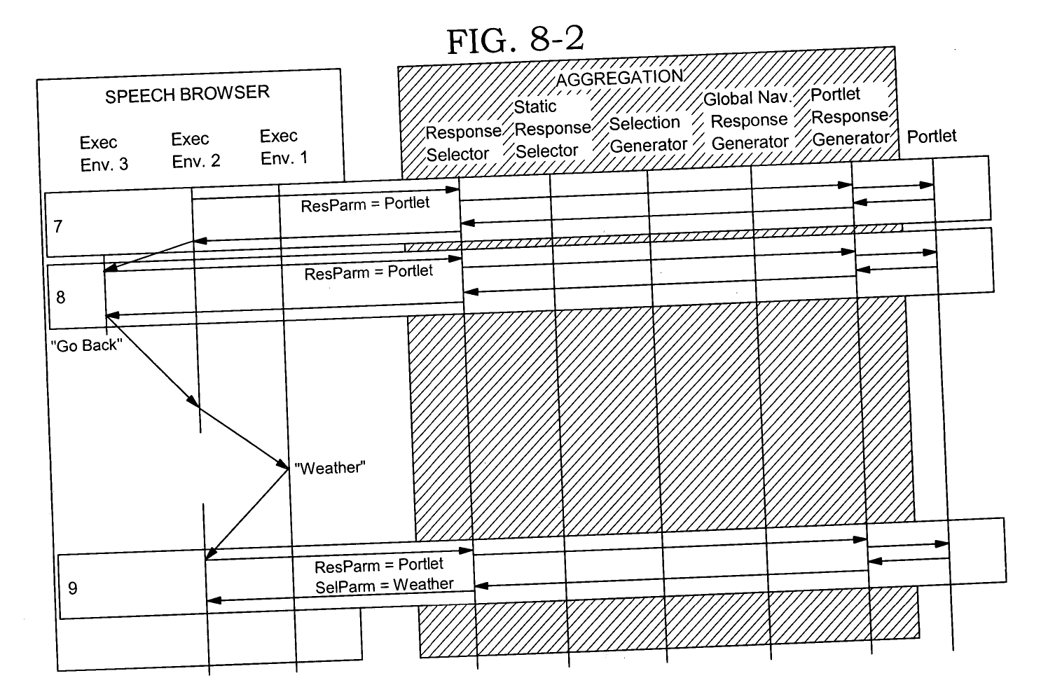

With respect to FIG. 8, there are depicted the request flow between Voice Server System and Portal Server System when using the present invention according to FIG. 6 B.

The FIG. 8 shows the request flow between the Voice Server system and Portal Server System. Only the relevant parts of them are shown in the diagram, which are Speech Browser and Aggregation. The Http-request between Speech Server and Portal Server System will carry additional parameters to modify the state or select the type of response, which are the Selection Parameter (SelectParm) and the Response Parameter (ResParm). The values for the parameters shown here, are examples. Most likely, the used parameter encoding will differ and use internal representations of these values.

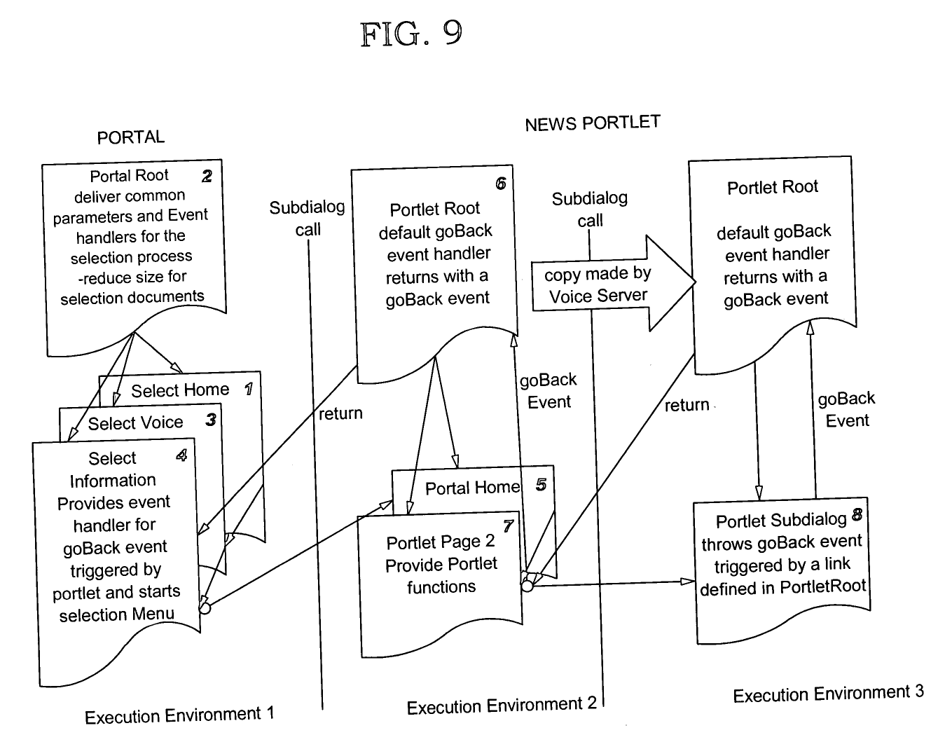

1. When a speech browser is started, it prepares an execution environment Exec Environment 1 for the interpretation of the VXML document and issues a HTTP request to get the initial document (see FIG. 9 Selection Home document 1). Since the user should be able to access the navigation structure at the navigation root, the SelParm is indicating this. The state modifier (not explicitly shown in this diagram) is using this information to reset the selection state, and forwards the HTTP request to the response selector. The response selector uses the ResParm to determine, that the response should come from the Select Generator, requests the response and sends it back in the HTTP response to the execution environment.

2. The execution environment starts the interpretation of the Selection Home document and detects, that this document is referring to a Portal Root document (Navigation information document), which is not loaded yet. Because of that, it is issuing another HTTP Request for this document. The response selector uses the ResParm to detect, that this document has to be sent back and involves the Static Response Generator to generate it and returns it in the HTTP Response.

The execution environment 1 resumes the interpretation of both documents and presents the user a dialog, to select one of the children of the Root navigation node. (In the previous example of a navigation structure this would be “Speech” or “Voice”)

3. A user selection (for example “Voice”) will trigger the execution environment to request another selection document (see FIG. 9 Select Voice), indicating the current user selection in the SelParm. The state modifier will update the portal state to the one selected by the user, and the response selector will again invoke the select generator to generate the HTTP response. Since the current selection state in the aggregation is now different than in the first request, a different response will be generated, holding a dialog to select between the children of the currently selected navigation node.

4. Since this document refers to the same application root document (see FIG. 9 Portal Root 2), which is already loaded, no request for this document is generated, and the selection dialog is immediately presented to the user, which selects a child node, as example “Information”. This will trigger the execution environment to request another selection document (see FIG. 9 Select Information 4), indicating the current user selection in the SelParm. The state modifier will update the portal state to the one selected by the user, and the response selector will again invoke the select generator to generate the HTTP response. Since the current selection state in the aggregation is now different than in the first request, a different response will be generated, holding a dialog to select between the children of the currently selected navigation node.

5. The selection of a Voice Portlet (“News”) will result in the creation of a new execution environment 2 (see FIG. 9 Voice Portlet Page 1) since the VXML document holds the directive to include the Voice Portlet dialog as subdialog. This isolates the execution of the Voice Portlet generated VXML into another execution environment, which is not allowed to modify the first execution environment. By doing so, the Voice Portlet execution is separated from the Portal execution resulting in a higher portal stability, since problems in a Voice Portlet will not influence the Portal. This new execution environment 3 is now issuing a HTTP request indicating the current Voice Portlet selection and requesting the Voice Portlet output. The state modifier will update the portal state to the one selected by the user, and the response selector will invoke the Voice Portlet response generator to generate the HTTP response. This generator will use the Voice Portlet to generate the complete VXML document, which will hold a reference to a different Voice Portlet specific application root document.

6. The new execution environment 3 starts the interpretation of the document and detects, that this document is refering to an application root document (see FIG. 9 Voice Portlet Root), which is not loaded yet. Because of that, it is issuing another HTTP Request for this document. The response selector uses the ResParm to detect, that the Voice Portlet application root document has to be sent back and involves the Global Navigation Generator to generate a VXML document specific for this selection and returns it in the HTTP Response. The execution environment resumes the interpretation of both documents and presents the user Voice Portlet specific dialogs.

7. One of the dialogs may end up in another request to the portal, requesting further output from the Voice Portlet, which is indicated in the ResParm. Again, the response selector will invoke the Voice Portlet via the Voice Portlet response generator to create the HTTP response. Since the generated VXML document refers to the same application root document, which is already loaded to the new execution environment, no request for it will be generated.

8. The Voice Portlet itself may also use subdialogs, to do common functions. Starting such a subdialog, again involves the creation of a new execution environment (Exec Env 3) and, if the subdialog is contained in a different VXML document, starts again a request to get the Voice Portlet output. As in the previous step, the output will be generated. How Voice Portlet determines, which document to generate, is out of the scope of this description, but it is usually done by using additional request parameters. Since the Speech browser detects, that the referred application root document is the same, as the one already used in the previous execution environment (Exec Env 2) no request for this document is generated, but a copy of it is made and inserted into the new execution environment (Exec Env 3).

If the user now issues a global navigation command like “go back” the link in the current application root document of the execution environment 3 will be activated and generate and goback event. This event will be caught by an event handler in the same application root document, which ends the current execution environment, returns to the previous one and throws the same event there. Since all Voice Portlet VXML documents have the same application root document, the event is handled in the same way in the execution environment 2. It is exited and the event is thrown again in the execution environment 1, the execution environment of the portal. The selection document and the application root document for the portal have different event handlers, which now invoke the right action. In the case of a goback event, the selection menu will be played to the user. So far, the Speech browser used only VXML documents, which are already loaded in an execution environment and because of that, no HTTP request for a new document has to be generated.

The major effect of this event handling is that all the execution environments used for executing Voice Portlet generated VXML are exited in a defined way and the resources are returned to the Speech Browser system. The current example shows, that it works for 2 levels of Voice POrtlet execution environments, but the iterative coding allows any level of subdialogs and thus execution environments being used in the Voice Portlet, and thus puts no restrictions on the coding of the Voice Portlets.

9. If the user selects another Voice Portlet, the output of this Voice Portlet is requested according to step 5.

1. A Portal Application (9) for a Voice Portal, wherein said Portal application (9) runs on a Portal server system (8) providing access to Voice Portlets (20), and a Voice application (4) that runs on a Voice server System connected via network with said Portal Server System (8) and connected via a network with phones, wherein said Portal application (9) provides navigation information to said Voice application for its execution, wherein said Portal application is characterized by:
a selection document generator (14) that has access to a navigation structure model (15), and which provides the functionality to create documents containing portal selection information derived from said navigation structure model,
a Portal global navigation adder (18) that provides the functionality to assign during runtime global navigation information to said documents containing portal selection information generated by said selection document generator,
a Voice Portlet global navigation adder (19) that provides the functionality to assign during runtime global navigation information to a Voice Portlet document provided by said Voice Portlet (20).

2. The Portal application according to claim 1, wherein said Portal global navigation adder and said Voice Portlet global navigation adder assign said global navigation information by extending said documents containing portal selection information and said Voice Portlet document with said global navigation information.

3. The Portal application according to claim 1, wherein said Portal global navigation adder and said Voice Portlet global navigation adder provides the functionality to assign said global navigation information by inserting a reference in said documents containg portal selection information, and said voice Portlet documents to another document containing said global navigation information.

4. The Portal application according to claim 1, wherein said Voice Portlet global navigation adder has access to a page composition model that defines the information that Voice Portlets belong to a page, and wherein said Voice Portlet global navigation adder provides the further functionality to assign said page composition model information to said Voice Portlet document.

5. The Portal application according to claim 1, wherein said global navigation information comprises
the functionality “go back” that ends the Voice Portlet and returns to the previous selection document,
the functionality “name of another Voice Portlet application” that ends the current Voice Portlet dialog and starts another Voice Portlet,
the functionality “Portal Home” that ends the current Voice portlet document and presents the initial selection document,
the functionality “hang up” that ends the dialog with the Voice portlet document and hangs up the phone line,
and the functionality “next application” that ends the current Voice Portlet document and starts another Voice Portlet documents, which is the next on the page.

6. The Portal application according to claim 1, wherein said network between said Portal Server System and said Voice Server System is the Internet or a Intranet.

7. A Portal application for a Voice Portal, wherein said Portal application runs on a Portal Server system providing access to Voice Portlets, a Voice application that runs on a Voice Server System connected via network with said Portal Server system and connected via a network with phones, wherein said Portal application provides navigation information to said Voice application for its execution, wherein said Voice application is characterized by:
providing the functionality to receive from said Portal application any document containing Portal selection information with assigned global navigation information, and to execute said document with its assigned global navigation information by creating an execution environment that provides only access to the global navigation information assigned to said document, and to receive from said Portal application any Voice Portlet document with assigned global navigation information, and to execute said Voice Portlet by calling a sub-dialog that creates an addition execution environment for said Voice Portlet document with said assigned global navigation information that provides only access to said global navigation information assigned to said Voice Portlet.

8. A Voice Portal, wherein said Voice Portal consists of a Portal application that runs on a Portal Server System, and a Voice application that runs on a Voice Server System connected via network with said Portal application and connected via a network with phones, wherein said Portal application provides navigation information to said Voice application for its execution, wherein said Voice Portal comprises
the Portal application that includes: a selection document generator that has access to a navigation structure model, and which provides the functionality to create documents containing portal selection information derived from said navigation structure model,
a Portal global navigation adder that provides the functionality to assign during runtime global navigation information to said documents containing portal selection information generated by said selection document generator,
a Voice Portlet global navigation adder that provides the functionality to assign during runtime global navigation information to a Voice Portlet document provided by said Voice Portlet,
a voice application that provides the functionality to receive from said Portal application any document containing Portal selection information with assigned global navigation information, and to execute said document with its assigned global navigation information by creating an execution environment that provides only access to the global navigation information assigned to said document, and to receive from said Portal application any Voice Portlet document with assigned global navigation information, and to execute said Voice Portlet by calling a sub-dialog that creates an addition execution environment for said Voice portlet document with said assigned global navigation information that provides only access to said global navigation information assigned to said Voice Portlet.

9. A method for creating navigation information for a Voice Portal, wherein said Voice Portal comprises a Portal application that runs on a Portal Server System, and a Voice application that runs on a Voice Server system connected via network with said Portal Server system and connected via a network with phones, wherein said Portal application provides navigation information derived from a navigation structure model to said Voice application for its execution, wherein said method at said Portal application side comprises the steps of:
creating a document containing Portal selection information derived from said navigation structure model provided by said portal application
assigning global navigation information to said document during runtime,
providing said document with its assigned global navigation information to said Voice Server System for its execution,
creating a Voice Portlet document,
assigning global navigation information to said Voice Portlet during runtime,
providing said Voice Portlet document with its assigned global navigation information to said Voice Server System for its execution,
wherein said Voice Portlet document is coded in a markup language that allows to call the Voice Portlet by said Voice application as a sub-dialog resulting in an own execution environment for said Voice Portlet with its assigned global navigation information separated from the execution environment of said document containing said Portal selection information with its own navigation information.

10. A method according to claim 9, wherein said navigation structure model is a navigation tree.

11. A method according to claim 10, wherein at each level of said navigation tree Voice Portlets can be arranged.

12. A method according to 9, wherein said markup language is VoiceXML.

13. A computer program product stored in the internal memory of a digital computer, containing parts of software code to execute the method in accordance with claims 9 to 12 if the product is run on the computer.
